(19) United States
(12) Patent Application Publication
(10) Pub. No.: US 2018/0328541 A1
(43) Pub. Date: Nov. 15, 2018

(54) Heating Systems for Film Growth Inhibition for Cold Flow

(71) Applicants: Jason W. Lachance, Magnolia, TX (US); Larry D. Talley, Friendswood, TX (US); Charles J. Mart, The Woodlands, TX (US)

(72) Inventors: Jason W. Lachance, Magnolia, TX (US); Larry D. Talley, Friendswood, TX (US); Charles J. Mart, The Woodlands, TX (US)

(21) Appl. No.: 15/953,893

(22) Filed: Apr. 16, 2018

Related U.S. Application Data
(60) Provisional application No. 62/505,411, filed on May 12, 2017.

(51) Int. Cl. F17D 1/18; F17D 1/08; B08B 7/00; B08B 9/027; F17D 3/12; C09K 8/52; C09K 8/524

(52) U.S. Cl. CPC F17D 1/18; F17D 1/088; B08B 7/0071; B08B 9/027; C09K 2208/22; C09K 8/52; C09K 8/524; B08B 2220/01; F17D 3/12

(57) ABSTRACT

A method of transporting a mixed phase fluid in a conduit. A hydrate and/or wax film is permitted to deposit on an inner wall of the conduit in a conversion zone, the conversion zone being less than a length of the conduit. A quantity of heat is applied to the conduit in the conversion zone until the hydrate and/or wax deposited on the inner wall in the conversion zone separates therefrom, thereby inhibiting the continual formation of hydrates and/or wax on the inner wall. The separated hydrates and/or wax are flowed in the mixed phase fluid.

### CROSS-REFERENCE TO RELATED APPLICATION

This application claims the benefit of U.S. Provisional Patent Application 62/505,411 filed May 12, 2017 entitled HEATING SYSTEMS FOR FILM GROWTH INHIBITION FOR COLD FLOW, the entirety of which is incorporated by reference herein.

### FIELD OF THE INVENTION

Aspects of the disclosure are directed to flow of multiphase fluids in a conduit, and more particularly, to methods and systems to maintain the flow of such multiphase fluids at ambient temperatures conducive for the formation of clathrates and or wax in the conduit.

### BACKGROUND

Clathrate hydrates (commonly called hydrates) are composites formed from a water matrix and a guest molecule, such as methane or carbon dioxide, among others. The presence of water in hydrocarbon production fluids may cause problems while transporting hydrocarbon fluids because of the formation of clathrate hydrates with hydrocarbon gases.

Various expensive techniques have been used to lower or reduce the ability for hydrates to form or cause plugging or fouling. These techniques include pipeline insulation, dehydration of the hydrocarbon-containing fluids, and adding hydrate inhibitors such as thermodynamic hydrate inhibitors ((THIs) and low dosage hydrate inhibitors (LDHIs). Examples of LHDIs include kinetic hydrate inhibitors (KHIs) and anti-agglomerates (AAs).

The hydrate-stability phase envelope includes the region on a temperature versus pressure diagram wherein hydrates may form because temperatures are sufficiently low, or pressures are sufficiently high, or both. Hydrates may form, for example, at the high pressures and low temperatures that may be found in pipelines and other hydrocarbon transportation equipment. After forming, hydrates can agglomerate, leading to plugging or fouling of the equipment. Hydrates can plug flow lines or other conduits by either forming large aggregates that plug the conduit, by film growth that constricts the conduit creating increased pressure drop, or a combination of these effects. Additionally, hydrate agglomeration can combine with other typical problems in conduit systems (for example, wax build-up) to create more difficult plugging issues.

When an effective level of kinetic hydrate inhibitors is in use, the conduit is generally free of hydrates both on the conduit wall as well as in the bulk flowing fluids. However, if the level of hydrate inhibitor is slightly low or during upset conditions a hydrate film can form on the wall of a conduit. This hydrate film along the wall can seed hydrate formation in the bulk flowing fluid. Further, when a hydrate film forms on the wall of a conduit, that hydrate film can seed hydrate formation in the bulk flowing fluid even when the bulk flowing fluid is treated with a KHI.

In contrast to KHIs, AAs allow hydrates to form, but the hydrates formed in the bulk liquid are generally limited in size and do not stick/adhere to each other. Besides hydrate formation in the bulk liquid, water film that forms on the conduit wall can form hydrates. Some AAs can slow hydrate film growth on conduit walls, but fail to altogether prevent hydrate film growth, which can ultimately lead to long term remediation efforts.

Still another technique is known as hydrate cold flow in which hydrates are permitted to form in the hydrocarbon fluid but are prevented from becoming attached to a conduit wall using various strategies. A common problem with hydrate cold flow is that while hydrates do not stick to the wall from the bulk phase, water films do form on the pipe wall and are then converted in situ to hydrate films. In many instances these water films form faster than systems using AAs. These hydrate films then grow slowly as additional water coats them and converts to hydrates. The process of hydrate film growth on the conduit wall is similar in end result to ice frost formation. Similarly, wax deposits may form the same way but by paraffin components in the crude oil that continually build up.

One method of preventing hydrate film growth is suggested in U.S. Patent Application Publication No. 2015/0260348, the disclosure of which is incorporated by reference herein in its entirety. The '348 application teaches that hydrate film growth may be prevented by using an additive that adheres to the conduit walls and inhibits hydrate growth only on the wall. The formation of hydrates in the bulk fluids continues, resulting in a fluid comprised of flowable hydrate particles carried along by the liquid fluids, including oil and water that has not been converted into hydrates. The fluid flow remains unrestricted because hydrates neither adhere to nor form on the pipe wall. However, the use of additives may require extra equipment for the injection, filtering, and/or recycling of the additive, thereby adding extra cost to a pipeline project.

Another method of preventing formation of hydrates may be to heat the pipeline. Conventional pipeline heating systems are designed to conserve the temperature of a pipeline fluid to prevent solids formation, especially wax and hydrates. In principle, conventional pipeline heating systems can be used at much higher power levels to melt hydrates and wax in a fluid. But conventional pipeline heating systems are not as suited for remediation of solids after their formation as it is for prevention of their formation. The reason is that the heat of fusion required to melt solids (the energy to effect a phase change) is much larger than the heat required to hold a fluid at constant temperature.

Traditionally, conventional pipeline heating systems are applied over the entire pipe length to maintain a fluid temperature above the hydrate or wax equilibrium temperatures, which takes a lot of power over long pipelines. What is needed is a way to prevent the formation of hydrate films within a pipeline that does not require large volumes/transport of expensive additives or traditional power-intensive pipeline heating systems.

### SUMMARY OF THE INVENTION

The invention provides a method of transporting a mixed phase fluid in a conduit. A hydrate and/or wax film is permitted to deposit on an inner wall of the conduit in a conversion zone, the conversion zone being less than a length of the conduit. A quantity of heat is applied to the conduit in the conversion zone until the hydrate and/or wax deposited on the inner wall in the conversion zone separates therefrom, thereby inhibiting the continual formation of hydrates and/or wax on the inner wall. The separated hydrates and/or wax are flowed in the mixed phase fluid.

The invention also provides a system for heating a conduit. The conduit has a length and an inner wall and is configured to transport a mixed phase fluid. A heating element is positioned only in a conversion zone of the conduit, the conversion zone being defined as a portion of the conduit between a first location where a temperature of the inner wall is at a temperature at which hydrates and/or wax form in the mixed phase fluid, and a second location where a temperature of the inner wall is equal to an ambient temperature. The heating element is configured to be actuated to heat the conduit within the conversion zone until hydrates and/or wax deposited on the inner wall in the conversion zone separate therefrom and flow in the mixed phase fluid, thereby inhibiting continual formation of hydrates and/or wax on the inner wall.

### BRIEF DESCRIPTION OF THE FIGURES

FIG. 1 is a simplified diagram of a subsea hydrocarbon production field.

FIG. 2 is a cross-sectional view of a conduit.

FIG. 3 is a detail view of an inner wall of the conduit in FIG. 2.

FIG. 4 is a cross-sectional view of a conduit.

FIG. 5 is another cross-sectional view of a conduit.

FIG. 6A is a schematic diagram of a conduit according to disclosed aspects.

FIG. 6B is a cross-sectional view of a conduit.

FIG. 6C is a side elevational view of an outer wall of a conduit according to disclosed aspects.

FIG. 6D is a cross sectional view of a conduit according to disclosed aspects.

FIG. 7 is a graph useful for determining the location of a conversion zone according to disclosed aspects.

FIG. 8 is a graph showing accumulation of hydrates and/or wax on an inner wall of a conduit in the respective conversion zone as a function of time according to disclosed aspects.

FIG. 9 is a schematic diagram of a conduit according to disclosed aspects.

FIG. 10 is a perspective view of a conduit.

FIG. 11 is a flowchart of a model according to disclosed aspects.

FIG. 12 is a flowchart of a method according to disclosed aspects.

### DETAILED DESCRIPTION

Various specific aspects and versions of the present disclosure will now be described, including preferred aspects and definitions that are adopted herein. While the following detailed description gives specific preferred aspects, those skilled in the art will appreciate that these aspects are exemplary only, and that the present invention can be practiced in other ways. Any reference to the “invention” may refer to one or more, but not necessarily all, of the aspects defined by the claims. The use of headings is for purposes of convenience only and does not limit the scope of the present invention. For purposes of clarity and brevity, similar reference numbers in the several Figures represent similar items, steps, or structures and may not be described in detail in every Figure.

All numerical values within the detailed description and the claims herein are modified by “about” or “approximately” the indicated value, and take into account experimental error and variations that would be expected by a person having ordinary skill in the art.

As used herein, “clathrate” is a composite made of a host compound that forms a basic framework and a guest compound that is held in the host framework by inter-molecular interaction, such as hydrogen bonding, Van der Waals forces, and the like. Clathrates may also be called host-guest complexes, inclusion compounds, and adducts.

As used herein, “clathrate hydrate” and “hydrate” are interchangeable terms used to indicate a clathrate having a basic framework made from water as the host compound. A hydrate is a crystalline solid which looks like ice, and forms when water molecules form a cage-like structure around a “hydrate-forming constituent.”

A “hydrate-forming constituent” refers to a compound or molecule in petroleum fluids, including natural gas, which forms a hydrate at elevated pressures, reduced temperatures, or both. Illustrative hydrate-forming constituents include, but are not limited to, hydrocarbons such as methane, ethane, propane, butane, neopentane, ethylene, propylene, isobutylene, cyclopropane, cyclobutane, cyclopentane, cyclohexane, and benzene, among others. Hydrate-forming constituents can also include non-hydrocarbons, such as oxygen, nitrogen, hydrogen sulfide, carbon dioxide, sulfur dioxide, and chlorine, among others.

“Exemplary” is used exclusively herein to mean “serving as an example, instance, or illustration.” Any embodiment described herein as “exemplary” is not to be construed as preferred or advantageous over other embodiments.

A “conduit” as used herein is an enclosed flow space such as flow lines, pipelines, flexibles, flexible risers, and other types of enclosed flow spaces. A conduit is not restricted to flow spaces with a cylindrical shape (i.e., with a generally circular axial cross-section), but is instead intended to encompass enclosed flow spaces of any desired cross-sectional shape, such as rectangular, oval, annular, non-symmetrical, etc. In addition, the term “conduit” contemplates enclosed flow spaces whose cross-sectional shape or size varies along its length.

A “mixed phase fluid” as used herein is a fluid containing constituents at two or more phases of matter. For example, a liquid-solid mixed phase fluid contains liquid matter and solid particulate matter flowing within the liquid. Two immiscible liquids may form so-called liquid-liquid mixed phase fluids. A gas and liquid dispersion is a gas-liquid mixed phase fluid containing a liquid and dispersed gas bubbles within the flowable fluid mixture.

A “facility” as used herein is a representation of a tangible piece of physical equipment through which hydrocarbon fluids are either produced from a reservoir or injected into a reservoir. In its broadest sense, the term facility is applied to any equipment that may be present along the flow path between a reservoir and the destination for a hydrocarbon product. Facilities may include production wells, injection wells, well conduits, wellhead equipment, gathering lines, manifolds, pumps, compressors, separators, surface flow lines and delivery outlets. In some instances, the term “surface facility” is used to distinguish those facilities other than wells. A “facility network” is the complete collection of facilities that are present in the model, which would include all wells and the surface facilities between the wellheads and the delivery outlets.

The term “FSO” refers to a Floating Storage and Offloading vessel. A floating storage device, usually for oil, is commonly used where it is not possible or efficient to lay a pipe-line to the shore. A production platform can transfer hydrocarbons to the FSO where they can be stored until a tanker arrives and connects to the FSO to offload it. A FSO may include a liquefied natural gas (LNG) production platform such as a floating LNG (FLNG) platform. The concept of a FSO may also include a floating production storage and offloading (FPSO) unit or any other floating facility designed to process and store a hydrocarbon prior to shipping.

A “formation” is any finite subsurface region. The formation may contain one or more hydrocarbon-containing layers, one or more non-hydrocarbon containing layers, an overburden, and/or an underburden of any subsurface geologic formation. An “overburden” and/or an “underburden” is geological material above or below the formation of interest.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state. As used herein, “fluid” is a generic term that may include either a gas or vapor.

A “hydrocarbon” is an organic compound that primarily includes the elements hydrogen and carbon although nitrogen, sulfur, oxygen, metals, or any number of other elements may be present in small amounts. As used herein, hydrocarbons generally refer to organic materials that are transported by pipeline, such as any form of natural gas or oil. A “hydrocarbon stream” is a stream enriched in hydrocarbons by the removal of other materials such as water and/or any additive.

The term “cold flow” refers to a process that utilizes mostly mechanical means, e.g., static mixers, to achieve low viscosity hydrate slurry formation. The cold flow hydrate slurry may be analytically indistinguishable from the anti-agglomerant hydrate slurry, but its formation process is distinguishable.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gauge pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

“Production fluid” refers to a liquid and/or gaseous stream removed from a subsurface formation, such as an organic-rich rock formation. Produced fluids may include both hydrocarbon fluids and non-hydrocarbon fluids. For example, production fluids may include but are not limited to oil, natural gas, and water.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Well” or “wellbore” refers to a hole in the subsurface made by drilling or insertion of a conduit into the subsurface. The terms are interchangeable when referring to an opening in the formation. A well may have a substantially circular cross section, or other cross-sectional shapes (for example, circles, ovals, squares, rectangles, triangles, slits, or other regular or irregular shapes). Wells may be cased, cased and cemented, or open-hole well, and may be any type, including, but not limited to a producing well, an experimental well, an exploratory well, or the like. A well may be vertical, horizontal, or any angle between vertical and horizontal (a deviated well), for example a vertical well may include a non-vertical component.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C1) as a significant component. Raw natural gas will also typically contain ethane (C2), higher molecular weight hydrocarbons, one or more acid gases (such as carbon dioxide, hydrogen sulfide, carbonyl sulfide, carbon disulfide, and mercaptans), and minor amounts of contaminants such as water, nitrogen, iron sulfide, wax, and crude oil.

Certain aspects and features have been described using a set of numerical upper limits and a set of numerical lower limits. It should be appreciated that ranges from any lower limit to any upper limit are contemplated unless otherwise indicated. All numerical values are “about” or “approximately” the indicated value, and take into account experimental error and variations that would be expected by a person having ordinary skill in the art.

All patents, test procedures, and other documents cited in this application are fully incorporated by reference to the extent such disclosure is not inconsistent with this application and for all jurisdictions in which such incorporation is permitted.

As previously explained, it has been proposed in the past to design flow lines and other conduits to prevent hydrate formation using insulation and electric heating (also known as heat tracing) along its entire length. However, it has been discovered that heating the entire length of a conduit is not necessary to prevent hydrate or wax films from depositing on the inner wall of the conduit. Described herein are methods and processes to heat only part of a conduit, known as limited flux heating (LFH), which allows the fluids to cool and only applies the limited heating until the fluids reach or are colder than the surrounding ambient temperatures. Such limited and intermittent heating to selected portions of a conduit significantly reduces the amount of heating components and operating power necessary to keep hydrocarbons flowing through a flow line or other conduit. Specific aspects of the disclosure include those set forth in the following paragraphs as described with reference to the Figures. While some features are described with particular reference to only one Figure, they may be equally applicable to the other Figures and may be used in combination with the other Figures or the foregoing discussion.

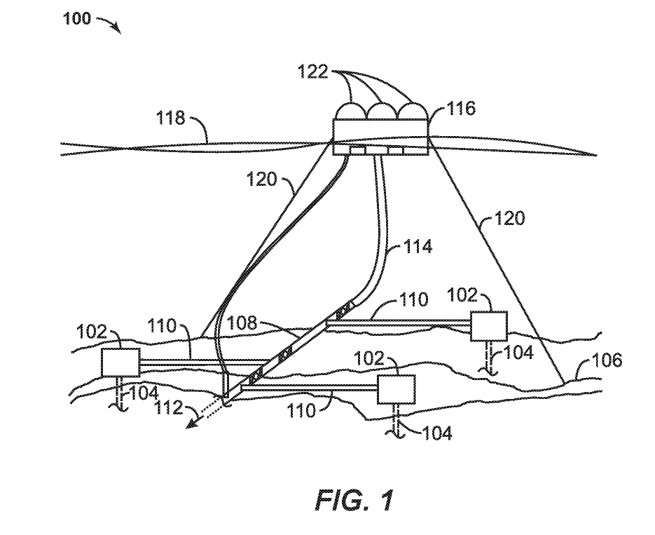

FIG. 1 is an illustration of a subsea hydrocarbon production field 100 that can be protected from hydrate and/or was plugging. However, the present techniques are not limited to subsea fields, but may be used for the mitigation of plugging in the production or transportation of oil, oil from oil sands, natural gas, any number of liquid or gaseous hydrocarbons from any number of sources including those located onshore, or any number of mixed phase fluids from any number of sources having the potential to form clathrate hydrates or wax deposits. As shown in FIG. 1, the field 100 can have a number of wellheads 102 coupled to wells 104 that harvest fluids from a formation (not shown). As shown in this example, the wellheads 102 may be located on the ocean floor 106. Each of the wells 104 may include single wellbores or multiple, branched wellbores. Each of the wellheads 102 may be coupled to a central pipeline 108 by gathering lines 110. The central pipeline 108 may continue through the field 100, coupling to further wellheads 102, as indicated by reference number 112.

A flexible line 114 may couple the central pipeline 108 to a collection platform 116 at the ocean surface 118. The collection platform 116 may, for example, be a floating processing station, such as a floating storage and offloading unit (or FSO), that is anchored to the sea floor 106 by a number of tethers 120. The collection platform 116 may have equipment for dehydration, purification, and other processing, such as liquefaction equipment to form purified hydrocarbons for storage in vessels 122. The collection platform 116 may transport the processed gas to shore facilities by pipeline (not shown). Alternatively, flexible line 114 may transport hydrocarbons directly to shore-based processing facilities.

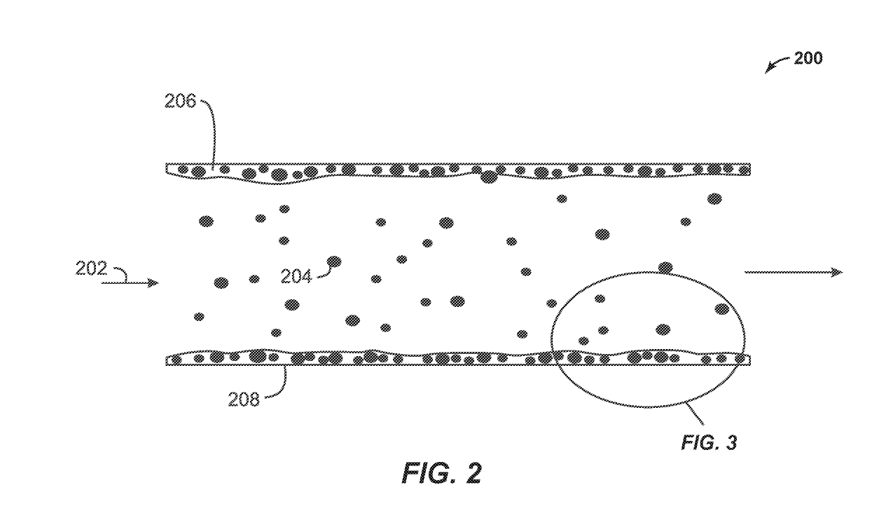

FIG. 2 illustrates the inside of a conduit 200 containing a mixed phase fluid 202 that is capable of producing hydrates 204. The hydrates 204 are shown aggregating together and may also form a hydrate film 206 on the inner wall 208 of the conduit. Sufficient inhibition of hydrate film growth can help to prevent plugging of the conduit. This may allow mixed phase fluid 202 to flow continuously and the conduit system 200 to operate primarily at steady state, for example, with mostly laminar flow.

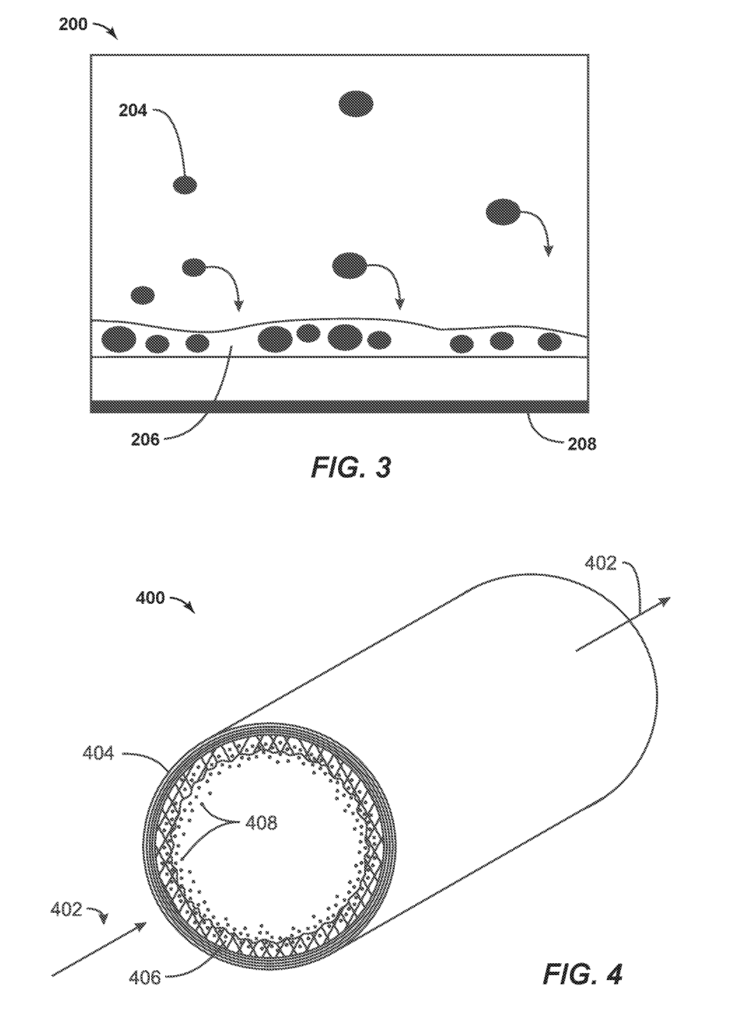

FIG. 3 illustrates a magnified view of hydrate film 206 that may form on inner wall 208 of conduit 200. In an untreated conduit carrying a mixed phase fluid capable of producing hydrates 204, hydrate particles may form and lead to formation of a hydrate film 206.

FIG. 4 is a diagram illustrating how in a mixed phase fluid 402 hydrate particles 408 may form on a film of water 406 proximate to the inner walls 404 of a conduit system 400. When too many hydrates 408 are formed in the film of water 406, fouling of the conduit system 400 may result, and can lead to costly and time-consuming remedial measures such as pigging the conduit system. It is possible that a parallel conduit system will need to be installed to prevent production interruptions due to the remedial measures (i.e. dual flow lines), thereby further increasing the cost of transporting the mixed phase fluid.

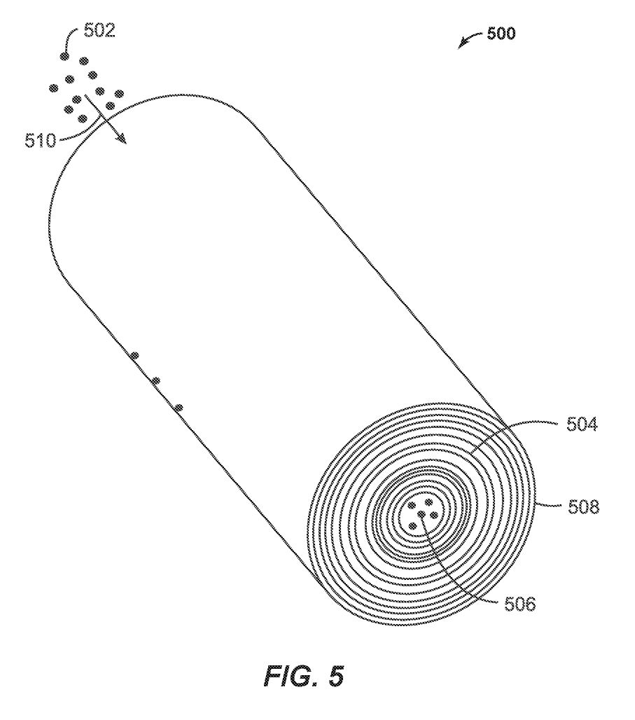

FIG. 5 is a diagram illustrating how the inner cross-sectional area of a conduit 500 decreases over time. As hydrate film growth creates layers of fouling 504 on the inner wall 508, these layers continue to grow and build upon one other as water continues to form a film on the hydrate film on the walls. Hydrate particles 502 produced in the mixed phase fluid 510 may begin to aggregate and form larger, more viscous hydrate particles 502 as time in the system increases. As the untreated system is in operation, film growth 504 on the inner wall 508 optionally combined with adhesion of hydrate particles formed in the bulk liquid to the hydrate film on the wall decreases the effective diameter of the conduit 500, and may, ultimately, plug the open region 506 within the conduit 500.

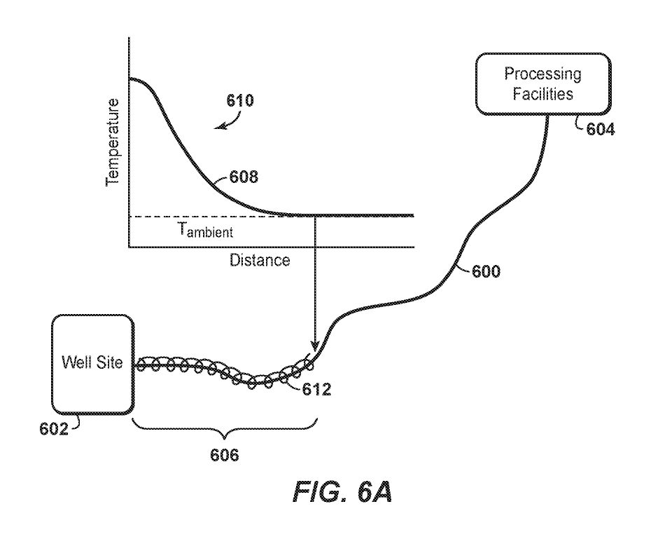

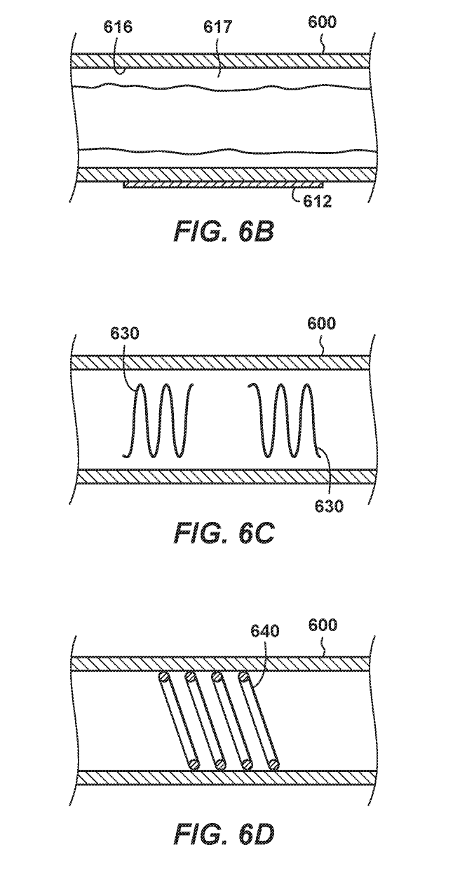

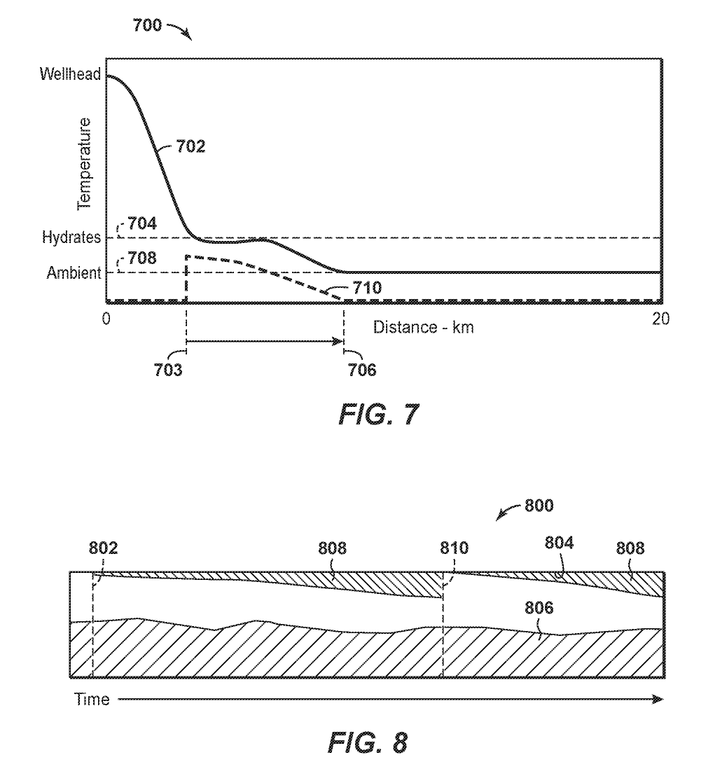

FIG. 6A is a schematic diagram of a conduit 600 disposed between a well site 602 and processing facilities 604. Conduit 600 may have a length of 10 km or greater, or a length of 15 km or greater, or a length of 20 km or greater, or a length of 50 km or greater, or a length of 100 km or greater, or a length of 200 km or greater. Line 608 in graph 610 shows how the temperature of a fluid in the conduit decreases to the ambient temperature 608. FIG. 7 is a graph 700 demonstrating a similar temperature curve 702 of fluid inside the conduit as a function of distance from a wellhead. The temperature of the fluid decreases rapidly between the wellhead and the location 703 where the fluid reaches a hydrate-forming temperature 704. Because hydrate formation is an exothermic reaction, the temperature curve 702 then slowly decreases during a hydrate-forming region until reaching the ambient temperature 708 at location 706. Beyond location 706, the fluid in the conduit is maintained substantially at the ambient temperature, and hydrates may continue to form in the fluid in the conduit. However, as demonstrated by the hydrate deposition curve 710, it has been discovered that hydrates begin to deposit on the inner wall of the conduit at temperature 704 and location 703 at a relatively high rate, and the rate of hydrate deposition decreases until the temperature of the fluid in the conduit reaches ambient temperature 708. Once the fluid in the conduit reaches ambient temperature 708, the rate of hydrate deposition is zero or substantially zero. Therefore, to prevent hydrate deposition, fluid in the conduit between location 703 and location 706 need only be treated. In other words, hydrate deposition in a conduit may be prevented by only treating the conduit where the fluid contained therein is between the hydrate forming temperature 704 and the ambient temperature 708. As these temperatures can be predicted and/or sensed, the portion of the conduit to be heated can also be predicted. Therefore, according to disclosed aspects, a process referred to as the limited flux heating (LFH) process applies a much smaller amount of heat to the pipeline than is used in conventional methods. For example, as shown in FIG. 6A only a portion 606 of the conduit 600 is designed to be heated. Portion 606 may be heated by various known types of heating systems, such as electric heating systems, resistive networks embedded in a riser or other conduit, indirect heating systems such as a fluid heat exchange system using coils, and the like. FIG. 6A schematically depicts the heating system as an electric heating system 612. The electrical heating system may include one or more conductive heating elements made of copper, aluminium, or other suitable materials. According to an additional aspect, portion 606 may only be heated intermittently, as will be further explained herein. Portion 606 corresponds to the region of the conduit where the temperature of the fluid contained therein is above the hydrate forming temperature. In another aspect, portion 606 corresponds to the region of the conduit where the temperature of the fluid contained therein is less than the hydrate forming temperature and greater than the ambient temperature. Portion 606 may be considered a hydrate conversion zone because this is the region where hydrates are formed. According to the disclosed aspects, hydrates and/or wax are allowed to deposit on the inner wall 616 (FIG. 6B) of the conduit, but after the hydrate and/or wax deposits 617 have achieved a certain thickness (depending on flow dynamics and input flux), the hydrate and/or wax deposits act like interior insulation. If portion 606 is then heated, the conduit and the outer surface of the deposited foulant (which may be hydrate and/or wax) are heated using electric heating system 612 to above its phase equilibrium of the foulant proximate to the pipe wall. Once this happens the hydrate and/or wax deposit will be destabilized such that it cannot continue to adhere to the inner wall of the conduit. Consequently, the hydrate and/or wax deposit will separate from the inner wall of the conduit and flow through the conduit. The electric heating system 612 may then be de-activated if desired until the temperature of the inner surface of the conduit once again equals or falls below the ambient temperature. Preferably the electric heating system is activated only until the hydrate and/or wax deposit is destabilized, to thereby prevent the electric heating system from needlessly heating the remainder of the fluid within the conduit.

Heating elements associated with the disclosed heating system may completely or partially extend around an external and/or internal surface of the conduit. FIG. 6C depicts an electric heating elements 630 disposed partially around a conduit 600. Further, any heating system coupled to an internal surface of the conduit must comprise a source of heat that can be safely be deployed inside the conduit without, for example, being a potential source of combustion. For example, when the heating system includes a coil 640 as shown in FIG. 6D, the coil may receive a fluid at a temperature above the solidification temperature of the hydrate and/or wax solids. The fluid within the coil 640 transfers heat to the conduit 600 according to known heat transfer principles. Examples of suitable fluids inside the coil may include any fluid whose temperature and/or flow rate can be controlled, and whose freezing point is substantially lower than that of the freezing hydrate and/or wax deposits. Examples of coil fluid include but are not limited to propane, methanol, and/or other commercially-available low-melting temperature heat transfer fluids.

In another aspect, the inner wall surface of the portion of a conduit in the above described hydrate forming region may be modified to prevent and/or destabilize adhesion of the hydrate and/or wax deposit thereto. Such modification may be accomplished by making the inner wall surface substantially smooth so that no hydrates and/or wax can adhere thereto. In other words, any protrusions on the inner wall surface are smoothed to a point where it is difficult or impossible for hydrates and/or wax to adhere to the wall. In effect, a fine layer of molecules, and particularly protruding molecules, is removed from the internal wall surface to obtain an internal wall surface that is smooth, and in some cases, the surface may have a nearly mirror-like finish. Non-limiting examples of the disclosed wall modification include (a) removing portions of the internal wall surface to obtain a substantially smooth surface, and (b) modifying the internal wall surface to include a coating surface.

Removing portions of the internal wall surface may include any method that can obtain a substantially smooth surface, such as mechanically and/or electrically removing material from the internal wall surface. Mechanically removing material from the internal wall surface may, for example, include sanding, grinding, sandblasting, and/or mechanically polishing the internal wall surface. Electrically removing material from the internal wall surface may, for example, include electropolishing the internal wall surface and/or laser ablating the internal wall surface. When the internal wall surface is electro-polished, an electrically-conductive solution may be held against the internal wall surface while electric current passes through the electrically-conductive solution. The electro-polishing may remove microscopic peaks of internal wall surface. Electrically removing the material may be preferred to mechanically removing the material because it may be easier to obtain a substantially smooth and homogenous surface.

Alternatively, the internal wall may be coated with any coating that can withstand the expected temperatures and pressures inside the conduit, and that provides non-stick characteristics. For example, the coating may be polytetrafluoroethylene (PTFE), which is considered to be low energy and can be made very smooth. Specifically, PTFE is not easily attracted to other components, so other components have difficulty adhering to PTFE. The coating may be any suitable thickness. For example, the coating thickness may be 100 microns to 300 microns, or about 100 microns to about 300 microns. Alternatively, the coating thickness may be 100 microns to 1 mm or about 100 microns to about 1 mm.

FIG. 8 is a schematic diagram of a location in a conduit 800 showing hydrate formation over time. At an initial time 802, the temperature of the inner wall 804 of the conduit is equal to the hydrate-forming temperature. Hydrates 808 begin to form and accumulate on the inner wall 804. As time increases, the temperature of the inner wall 804 decreases toward the ambient temperature due to hydrate insulation effects, which is achieved at a second time 810. According to aspects of the disclosure, the outer surface of the conduit is heated, which causes the deposited hydrates 808 to separate from the inner wall and flow in the hydrocarbon flow 806. The heating process may continue, or alternatively may be paused, and the hydrates once again begin to be deposited on the inner wall of the conduit.

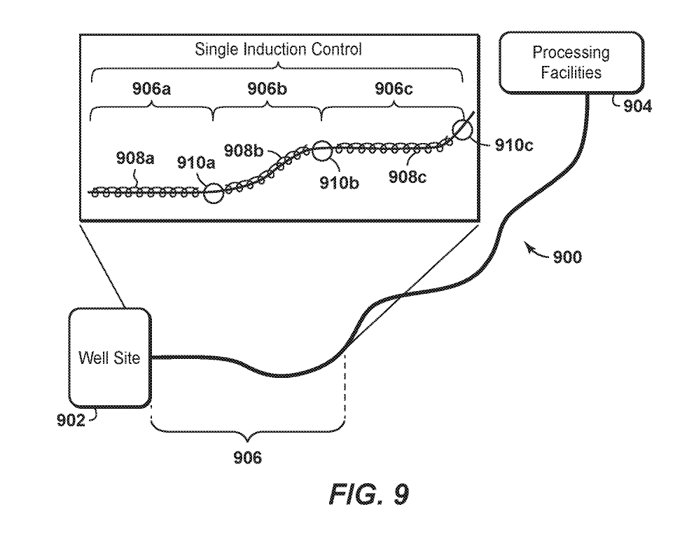

The electric heating system 612 shown in FIG. 6A may comprise one or more heating elements or mechanisms. For example, the electric heating system may comprise a plurality of heating elements arranged in series and directly adjacent each other. One or more of the heating elements may or may not be operated together. The heating elements may be operated together when connected to each other, and may be operated independently when not connected to each other. The independent operation of the heating elements may allow for optimal heating control of one or more parts of a portion of a conduit to be heated. FIG. 9 is a schematic diagram of a conduit 900 between a well site 902 and processing facilities 904. According to disclosed aspects, only a portion 906 of the conduit is electrically heated. Portion 906 corresponds to the hydrate conversion zone as previously described. The entire portion 906 may be heated, or as shown in FIG. 9, sub-portions 906a, 906b, 906c may be controlled to be heated at different time intervals using separately controlled portions 908a, 908b, 908c, respectively, of an electric heating system. The separately controlled portions 908a, 908b, 908c may comprise separate heating elements or mechanisms or may comprise portions of a single heating system. For example, in some circumstances hydrate deposits and/or wax deposits may be more likely to form at faster rates in sub-portion 906a, which is nearest to the well site 902, and therefore the electric heating elements associated with sub-portion 906a may be controlled to be heated continuously. Alternatively, the electric heating elements associated with sub-portion 906a may be intermittently actuated to be heated once per day. Sub-portions 906b, 906c may be less likely to have hydrate deposits and/or wax deposits formed therein, and therefore the heating elements associated with those sub-portions may be controlled to be intermittently actuated to be heated once every five days and once every two weeks, respectively. Of course, other intermittent actuation frequencies may be implemented depending on sensed or predicted hydrate formation and/or wax formation. The amount and/or size of the electric heating elements may depend on factors such as conduit size, wall thickness, fluid temperature and flow rate inside the conduit, and the temperature outside the conduit. To aid in determining whether or how often sub-portions 906a, 906b, 906c should be heated, temperature sensors 910a, 910b, 910c may be placed along portion 906, and preferably at the respective end of each sub-portion. These locations represent the place within each sub-portion having the lowest conduit temperature, and therefore provide a reliable indicator of maximum hydrate and/or wax film growth within the respective sub-portion. In an alternative aspect of the disclosure, portions 908a, 908b, 908c of the electric heating system may be actuated together to provide for simpler operation than is possible with separate or independent control.

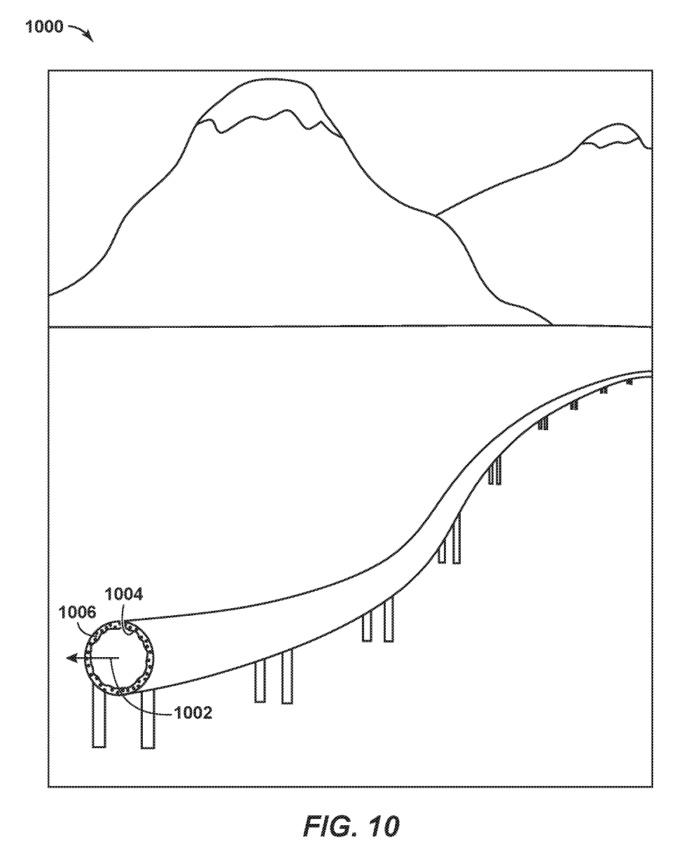

FIG. 10 is a perspective view of a surface pipeline 1000 for transporting hydrocarbons or other fluid streams over long distances. In pipelines 1000 that are untreated, and which have a mixed phase capable of producing hydrates and/or wax 1002, hydrate and/or wax particles may form and lead to fouling 1004 at the inner walls 1006 of the pipeline. When system parameters of sufficiently high pressure and low temperature have been established, the mixed phase fluid in the pipeline 1000 is placed in a condition where hydrate and/or wax formation becomes an issue. The techniques described herein can be implemented in surface pipelines such as these, helping to ensure a continuous rate of flow is maintained therein.

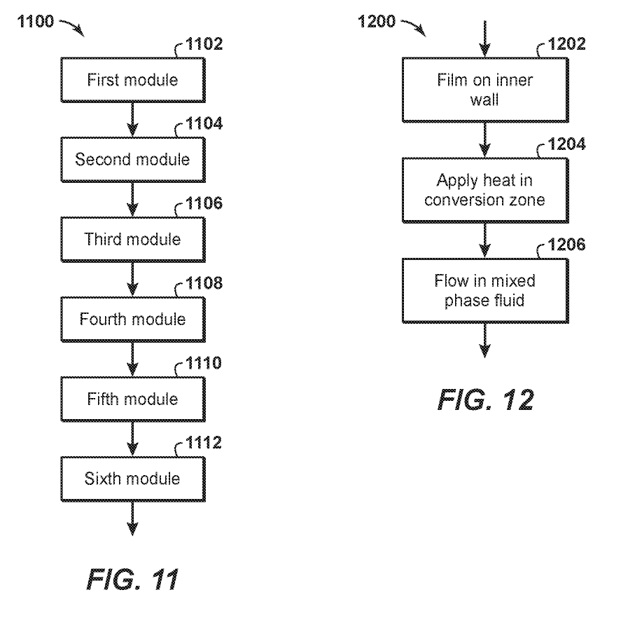

FIG. 11 is a schematic diagram of a model 1100 that may be used to predict the location and length of the hydrate and/or wax conversion zone according to aspects of the disclosure. The model 1100 incorporates multiphase flow dynamics hydraulic calculations concurrently with the hydrate/wax phase change process. Model 1100 includes a first module 1102 that uses sensed pressures and temperatures of the fluid in the conduit to determine whether hydrate/wax equilibrium is present in the fluid. A second module 1104 predicts the nucleation of hydrates/wax and the growth/dissociation rates of hydrates/wax based on mass and heat transfer principles. A third module 1106 predicts hydrate/wax aggregation tendencies and the impact on fluid viscosities based on these predicted tendencies. A fourth module 1108 predicts the concurrent hydrate/wax film growth and dissociation rates on or near the inner wall 616 of the conduit. A fifth module 1110 predicts the statistical probability (based on the outputs of the first through fourth modules 1102-1108 of plugging and/or achieving sufficient pressure drop to stop production fluid flow. A sixth module 1112 predicts the dissociation of hydrates/wax if hydrate/wax equilibrium conditions change (first module 1102) and the subsequent interactions with the second through fourth modules 1104-1108. Each of the first through sixth modules 1102-1112 may be included in a computer program or application that may run on any suitable general purpose or customized computer or computing system (not shown).

The disclosed aspects have especial applicability to cold flow technologies, which as previously described are designed to permit hydrates and/or wax to form in a conduit and flow along with the transported hydrocarbons. Reducing or eliminating hydrate deposits and/or wax deposits on the inside wall of the conduit maintains flow within the conduit even under low-temperature conditions.

FIG. 12 is a flowchart showing a method 1200 of transporting a mixed phase fluid in a conduit according to disclosed aspects. At block 1202 a hydrate and/or wax film is permitted to deposit on an inner wall of the conduit in a conversion zone. The conversion zone is less lied than a length of the conduit. At block 1204 a quantity of heat is applied to the conduit in the conversion zone until the hydrate and/or wax deposited on the inner wall in the conversion zone separates therefrom. The continual formation of hydrates and/or wax on the inner wall is thereby inhibited. At block 1206 the separated hydrates and/or wax are flowed in the mixed phase fluid.

The disclosed aspects provide a method of preventing hydrate and/or wax formation by electric heating of only a portion of a conduit. An advantage is a significant reduction in cost when compared to conventional heating systems. Especially for very long tiebacks or conduits, the disclosed LFH process requires a significantly shorter area to be equipped with electric heating components by allowing the fluids to cool and only applying LFH until the fluids reach or are colder than the surrounding ambient temperatures. In the case of a 200 km tieback this may reduce the needed electric heating system to only 6-10 km depending on the transported fluids. It is also envisioned that this process can be more fully optimized with the coupling to wellhead separation techniques.

Another advantage is that the disclosed aspects can be used advantageously with cold flow technologies and strategies, and that there would be no need to inject inhibition chemicals (e.g., methanol, AA, KHI, and the like) into the conduit. Still another advantage is that with an effective cold flow empowered by the disclosed aspects, dual pipeline systems required for pigging would not be needed. Yet another advantage is that the predictable formation of hydrate and/or wax deposits—as a function of temperature—enables an easily operable system to periodically slough off the deposits.

Aspects of the disclosure may be modified in many ways while keeping with the spirit of the invention. For example, the disclosed aspects have been described as principally used to eliminate hydrate deposits, but the disclosed aspects may be equally useful for the elimination of wax deposits, which exhibit similar temperature-based deposition behavior. Of course, the temperature(s) at which wax may be deposited on an inner wall of a conduit may be different from the hydrate deposition temperature(s), and therefore the locations and lengths of the electric heating components may differ. Additionally, the required frequency of actuation of the electric heating components may also differ for wax deposits. As a non-limiting example, one of the sub-portions 906b of portion 906 (FIG. 9) may be used to eliminate hydrate deposits, and another of the sub-portions 906a, 906c may be separately controlled to eliminate wax deposits.

Aspects of the disclosure may include any combinations of the methods and systems shown in the following numbered paragraphs. This is not to be considered a complete listing of all possible aspects, as any number of variations can be envisioned from the description above.

1. A method of transporting a mixed phase fluid in a conduit, comprising:
permitting a hydrate and/or wax film to deposit on an inner wall of the conduit in a conversion zone, the conversion zone being less than a length of the conduit;
applying a quantity of heat to the conduit in the conversion zone until the hydrate and/or wax deposited on the inner wall in the conversion zone separates therefrom, thereby inhibiting the continual formation of hydrates and/or wax on the inner wall; and
flowing the separated hydrates and/or wax in the mixed phase fluid.

2. The method of paragraph 1, further comprising:
converting at least a portion of water in the mixed phase fluid into non-agglomerating hydrates using a cold flow process; and
flowing the non-agglomerating hydrates in the mixed phase fluid.

3. The method of paragraph 1 or paragraph 2, wherein the cold flow process includes:
at a first location, injecting an additive into the mixed phase fluid to inhibit agglomeration of hydrates and/or wax; and
at a second location geographically separate from the first location, separating the additive from the mixed phase fluid.

4. The method of any of paragraphs 1-3, further comprising:
determining a first location along the conduit where a temperature of the inner wall is at a first temperature, the first temperature being a temperature at which hydrates and/or wax form in the mixed phase fluid;
determining a second location along the conduit where a temperature of the inner wall is equal to an ambient temperature; and
defining the conversion zone as between the first location and the second location.

5. The method of any of paragraphs 1-4, further comprising defining the conversion zone as beginning at the first location and ending at the second location.

6. The method of any of paragraphs 1-5, further comprising:
determining a temperature of the inner wall at one or more locations along the conduit using one or more sensors; and
determining at least one of the first location and the second location based on the sensed temperature.

7. The method of any of paragraphs 4-6, wherein the conversion zone is further defined by one or more of
(a) determining whether hydrate and/or wax equilibrium is present in the fluid, using sensed pressures and temperatures of the fluid in the conduit,
(b) predicting nucleation of hydrates and/or wax and growth/dissociation rates of hydrates and/or wax based on mass and heat transfer principles,
(c) predicting hydrate and/or wax aggregation tendencies and an impact on fluid viscosities based on said predicted tendencies,
(d) predicting concurrent hydrate and/or wax film growth and dissociation rates on or near the inner wall of the conduit,
(e) predicting a statistical probability of conduit plugging or achieving sufficient pressure drop to stop fluid flow in the conduit, said prediction of the statistical probability being based on steps (a)-(d) above, and
(f) predicting dissociation of hydrate and/or wax from the inner wall if conditions associate with the hydrate and/or wax equilibrium change.

8. The method of any of paragraphs 1-7, further comprising:
installing heating components to the conduit only within the conversion zone.

9. The method of any of paragraphs 1-8, further comprising:
dividing the conversion zone into a plurality of sub-zones; and
applying the quantity of heat intermittently at different time frequencies in each respective ones of the plurality of sub-zones.

10. The method of paragraph 9, wherein the plurality of sub-zones comprises a first sub-zone and a second sub-zone, and wherein more hydrates and/or wax form within the first sub-zone than in the second sub-zone, the method further comprising:
intermittently applying the quantity of heat in the first sub-zone at a greater time frequency than in the second sub-zone.

11. The method of any of paragraphs 1-10, wherein the quantity of heat is applied in an intermittent operation.

12. The method of any of paragraphs 1-11, wherein the conduit is uninsulated at least in the conversion zone.

13. The method of any of paragraphs 1-12, further comprising sanding, grinding, sandblasting, mechanically polishing, or electropolishing the inner wall of the conduit in the conversion zone.

14. The method of any of paragraphs 1-13, further comprising coating the inner wall of the conduit with a non-stick coating in the conversion zone.

15. The method of any of paragraphs 1-14, wherein the conversion zone is a hydrate conversion zone in which hydrates are permitted to deposit on the inner wall, and wherein the quantity of heat is a first quantity of heat, the method further comprising:
defining a wax conversion zone in which wax is permitted to deposit on the inner wall, the wax conversion zone being less than the length of the conduit; and
applying a second quantity of heat to the conduit in the wax conversion zone until the wax deposited on the inner wall in the wax conversion zone separates therefrom, thereby inhibiting continual wax formation on the inner wall.

16. The method of paragraph 15, further comprising:
applying the first quantity of heat independently from applying the second quantity of heat.

17. A system for heating a conduit, the conduit having a length and an inner wall, the conduit configured to transport a mixed phase fluid, the system comprising:
a heating element positioned only in a conversion zone of the conduit, the conversion zone being defined as a portion of the conduit between
a first location where a temperature of the inner wall is at a temperature at which hydrates and/or wax form in the mixed phase fluid, and
a second location where a temperature of the inner wall is equal to an ambient temperature;
wherein the heating element is configured to be actuated to heat the conduit within the conversion zone until hydrates and/or wax deposited on the inner wall in the conversion zone separate therefrom and flow in the mixed phase fluid, thereby inhibiting continual formation of hydrates and/or wax on the inner wall.

18. The system of paragraph 17, further comprising a temperature sensor located along the conduit.

19. The system of paragraph 17 or paragraph 18, wherein the conversion zone is divided into a first sub-zone and a second sub-zone such that more hydrates and/or wax form within the first sub-zone than in the second sub-zone, and wherein the heating element is actuated to provide more heat to the first sub-zone than to the second sub-zone.

20. The system of any of paragraphs 17-19, further comprising a non-stick coating applied to the inner wall of the conduit in the conversion zone.

21. The system of any of paragraphs 17-19, wherein the inner wall has been treated in the conversion zone using one of sanding, grinding, sandblasting, mechanically polishing, or electropolishing.

While the foregoing is directed to aspects of the present disclosure, other and further aspects of the disclosure may be devised without departing from the basic scope thereof, and the scope thereof is determined by the claims that follow.

What is claimed is:

1. A method of transporting a mixed phase fluid in a conduit, comprising:
permitting a hydrate and/or wax film to deposit on an inner wall of the conduit in a conversion zone, the conversion zone being less than a length of the conduit;
applying a quantity of heat to the conduit in the conversion zone until the hydrate and/or wax deposited on the inner wall in the conversion zone separates therefrom, thereby inhibiting the continual formation of hydrates and/or wax on the inner wall; and
flowing the separated hydrates and/or wax in the mixed phase fluid.

2. The method of claim 1, further comprising:
converting at least a portion of water in the mixed phase fluid into non-agglomerating hydrates using a cold flow process; and
flowing the non-agglomerating hydrates in the mixed phase fluid.

3. The method of claim 2, wherein the cold flow process includes:
at a first location, injecting an additive into the mixed phase fluid to inhibit agglomeration of hydrates and/or wax; and
at a second location geographically separate from the first location, separating the additive from the mixed phase fluid.

4. The method of claim 1, further comprising:
determining a first location along the conduit where a temperature of the inner wall is at a first temperature, the first temperature being a temperature at which hydrates and/or wax form in the mixed phase fluid;
determining a second location along the conduit where a temperature of the inner wall is equal to an ambient temperature; and
defining the conversion zone as between the first location and the second location.

5. The method of claim 4, further comprising defining the conversion zone as beginning at the first location and ending at the second location.

6. The method of claim 4, further comprising:
determining a temperature of the inner wall at one or more locations along the conduit using one or more sensors; and
determining at least one of the first location and the second location based on the sensed temperature.

7. The method of claim 4, wherein the conversion zone is further defined by one or more of
(a) determining whether hydrate and/or wax equilibrium is present in the fluid, using sensed pressures and temperatures of the fluid in the conduit,
(b) predicting nucleation of hydrates and/or wax and growth/dissociation rates of hydrates and/or wax based on mass and heat transfer principles,
(c) predicting hydrate and/or wax aggregation tendencies and an impact on fluid viscosities based on said predicted tendencies,
(d) predicting concurrent hydrate and/or wax film growth and dissociation rates on or near the inner wall of the conduit,
(e) predicting a statistical probability of conduit plugging or achieving sufficient pressure drop to stop fluid flow in the conduit, said prediction of the statistical probability being based on steps (a)-(d) above, and
(f) predicting dissociation of hydrate and/or wax from the inner wall if conditions associate with the hydrate and/or wax equilibrium change.

8. The method of claim 4, further comprising:
installing heating components to the conduit only within the conversion zone.

9. The method of claim 4, further comprising:
dividing the conversion zone into a plurality of sub-zones; and
applying the quantity of heat intermittently at different time frequencies in each respective ones of the plurality of sub-zones.

10. The method of claim 9, wherein the plurality of sub-zones comprises a first sub-zone and a second sub-zone, and wherein more hydrates and/or wax form within the first sub-zone than in the second sub-zone, the method further comprising:
intermittently applying the quantity of heat in the first sub-zone at a greater time frequency than in the second sub-zone.

11. The method of claim 1, wherein the quantity of heat is applied in an intermittent operation.

12. The method of claim 1, wherein the conduit is uninsulated at least in the conversion zone.

13. The method of claim 1, further comprising sanding, grinding, sandblasting, mechanically polishing, or electropolishing the inner wall of the conduit in the conversion zone.

14. The method of claim 1, further comprising coating the inner wall of the conduit with a non-stick coating in the conversion zone.

15. The method of claim 1, wherein the conversion zone is a hydrate conversion zone in which hydrates are permitted to deposit on the inner wall, and wherein the quantity of heat is a first quantity of heat, the method further comprising:
defining a wax conversion zone in which wax is permitted to deposit on the inner wall, the wax conversion zone being less than the length of the conduit; and
applying a second quantity of heat to the conduit in the wax conversion zone until the wax deposited on the inner wall in the wax conversion zone separates therefrom, thereby inhibiting continual wax formation on the inner wall.

16. The method of claim 15, further comprising:
applying the first quantity of heat independently from applying the second quantity of heat.

17. A system for heating a conduit, the conduit having a length and an inner wall, the conduit configured to transport a mixed phase fluid, the system comprising:
a heating element positioned only in a conversion zone of the conduit, the conversion zone being defined as a portion of the conduit between
a first location where a temperature of the inner wall is at a temperature at which hydrates and/or wax form in the mixed phase fluid, and
a second location where a temperature of the inner wall is equal to an ambient temperature;
wherein the heating element is configured to be actuated to heat the conduit within the conversion zone until hydrates and/or wax deposited on the inner wall in the conversion zone separate therefrom and flow in the mixed phase fluid, thereby inhibiting continual formation of hydrates and/or wax on the inner wall.

18. The system of claim 17, further comprising a temperature sensor located along the conduit.

19. The system of claim 17, wherein the conversion zone is divided into a first sub-zone and a second sub-zone such that more hydrates and/or wax form within the first sub-zone than in the second sub-zone, and wherein the heating element is actuated to provide more heat to the first sub-zone than to the second sub-zone.

20. The system of claim 17, further comprising a non-stick coating applied to the inner wall of the conduit in the conversion zone.

21. The system of claim 17, wherein the inner wall has been treated in the conversion zone using one of sanding, grinding, sandblasting, mechanically polishing, or electropolishing.
